(19) United States
(12) Patent Application Publication
(10) Pub. No.: US 2002/0019830 A1
(43) Pub. Date: Feb. 14, 2002

(54) System and method for the optimization of data collection

(76) Inventors: Max Hamberg, Vantaa (FI); Maija Saukko, Aanekoski (FI); Kimmo Poikolainen, Aanekoski (FI); Jukka Jarvi, Puuppola (FI); Tarmo Hyttinen, Liimattala (FI); Jari Kortesmaa, Aanekoski (FI)

Correspondence Address: Altera Law Group, 6500 City West Parkway - Suite 100, Minneapolis, MN, 55344-7701, US

(21) Appl. No.: 09/875,618

(22) Filed: Jun. 6, 2001

Related U.S. Application Data
(63) Continuation of application No. PCT/FI99/01014, filed on Dec. 7, 1999.

(30) Foreign Application Priority Data
Dec. 9, 1998 (FI) 982670

(51) Int. Cl. G06F 17/30

(52) U.S. Cl. 707/204; 707/104.1

(57) ABSTRACT

The present invention relates to a system and a method for the optimization of data collection in a telecommunication network, said system comprising a digital telephone exchange with a collection mechanism disposed in conjunction with it. By means of the collection mechanism, data is stored in storage locations; data is transferred from the storage locations; and data is backed up, and which system comprises a client application utilizing the collection mechanism. According to the invention, the storage, transfer and copying are implemented in a generic manner. The invention provides the advantage that one and the same mechanism can be used to handle multiple types of data, thus avoiding interpenetrating functions.

### FIELD OF THE INVENTION

The present invention relates to telecommunication. In particular, the invention relates to a new and advanced method and system for the optimization of data collection in telecommunication networks.

### BACKGROUND OF THE INVENTION

A central functional entity in telephone exchanges is the storage of different kinds of updated information. The storage locations may be either cumulative or record-based. In a cumulative storage location, it is possible to store e.g. a metering pulse count, new pulses being added to the pulse count already in the storage location. In a record-based storage location, it is possible to store e.g. call records from itemized metering, which are preserved as separate records. In general, data saved in a storage is removed from the exchange. It may also be desirable to make a backup copy of the data.

A problem with prior-art solutions is that the storage, transfer and copying functions have to be implemented separately for different data types. A consequence of this is that there is unnecessary interpenetration between these functions, which again gives rise to extra costs. A further consequence is the difficulty of achieving uniformity in software design.

The object of the invention is to disclose a new type of method that will eliminate the problems referred to above. A specific object of the invention is to disclose a system and a method in which different types of updated data are stored using a common mechanism, and in which the transfer and backup of data are carried out using a common mechanism.

### BRIEF DESCRIPTION OF THE INVENTION

The system for optimizing data collection in a telecommunication network according to the present invention comprises a digital telephone exchange, such as e.g. a mobile switching center or a wired-network exchange. The system comprises a collection mechanism used to handle data pertaining to the exchange in question, said data being generally of an updated type. The system also comprises one or more storage locations in which the data is stored. Moreover, the system comprises at least one client application that uses the services of the collection mechanism. According to the invention, the collection mechanism comprises a generic storage mechanism, by means of which multiple types of data can be stored in the storage locations. ‘Generic’ refers to a general-purpose mechanism such that one and the same entity can be used by several parties and/or for different purposes without the said entity having to be modified. In addition, according to the invention, the collection mechanism comprises a generic transfer mechanism, by means of which multiple types of data can be transferred from the storage locations, e.g. from the exchange to a post-processing system. Further, according to the invention, the collection mechanism comprises a generic copying mechanism, by means of which backup copies are made of multiple types of data. As the functions of storage, transfer and copying are implemented generically, multiple types of data can be handled by the same storage, transfer and copying mechanisms. Instead of using different implementations for the storage, transfer and copying of different files, a generic solution is used, in which different updated data types are stored using a common mechanism, and likewise the transfer and backup copying of different data types are effected using common mechanisms.

In an embodiment of the invention, the storage locations are of a cumulative and/or record-based type.

In an embodiment of the invention, the storage locations are disposed in RAM (Random Access Memory) and/or on a mass storage device buffered via RAM.

In an embodiment of the invention, a client application using data collection services gives the data intended to be stored to the collection mechanism.

In an embodiment of the invention, the client application determines via a scattering specification the storage locations in which the data is to be stored. Thus, the scattering specification can be defined e.g. in the application and given to the data collection services at run time when storage locations are to be created and data collection services are to be used. The client application may ask the data collection service for the data contained in a desired storage location. The client application refers to the storage location via the scattering specification, and the data collection services retrieve the contents of the actual storage location, which is returned to the client application.

In an embodiment of the invention, backup copying is managed using schedules that the client application gives to the collection mechanism. In the backup copying function, the storage locations in RAM are copied to a mass storage. The file contained in the storage locations is copied without its format being changed.

In an embodiment of the invention, the client application determines the format in which the data is to be transferred to post-processing. The transfer is performed either in accordance with schedules given by the client application or immediately. The collection mechanism directs the data toward the desired target, such as e.g. a text formatter and further to a printer.

In an embodiment of the invention, the client application is an application controlling traffic monitoring measurements, such as e.g. telephone traffic monitoring measurements. Statistical monitoring of the traffic collects statistically significant data relating to the operation of a network element and stores it in different statistical accumulators. Based on the stored data, various statistical measurements can be performed. According to the invention, the data comprises data to be included in the traffic monitoring measurements. Further, according to the invention, the system comprises a generic reporting mechanism, by means of which a measurement report is produced from the data in accordance with measurement-specific measurement specifications. According to the invention, the client application defines a measurement-specific measurement specification, which includes e.g. information giving the time when the measurement is to be performed, the objects to be covered by the measurement, the format to be used in the measurement report and the calculation formulas to be applied in creating the measurement report. As the means to be used are of a generic nature, the same measuring and reporting mechanism can be used to perform different measurements.

In an embodiment of the invention, the client application is an application performing metering functions. The purpose of the metering functions is to meter the consumption of resources and to store the metered consumption data separately for each consumer so that the resources consumed by a given consumer, e.g. a subscriber, can be invoiced later. According to the invention, the data includes consumer-specific consumption information. According to the invention, the metering is implemented by utilizing a generic data collection mechanism which can be used to store the consumption data, make a backup copy of it and transfer it to post-processing.

As compared with prior art, the present invention provides the advantage that data collection can be implemented in an optimal manner. As the storage, backup copying and transfer of data to post-processing are implemented as generic mechanisms, they can be used to handle multiple types of data. This makes it possible to avoid interpenetrating implementations typical of prior art, thus achieving cost savings. Moreover, software design is clarified and made easier.

### LIST OF ILLUSTRATIONS

In the following,. the invention will be described by the aid of a few examples of its embodiments with reference to the attached drawing, wherein

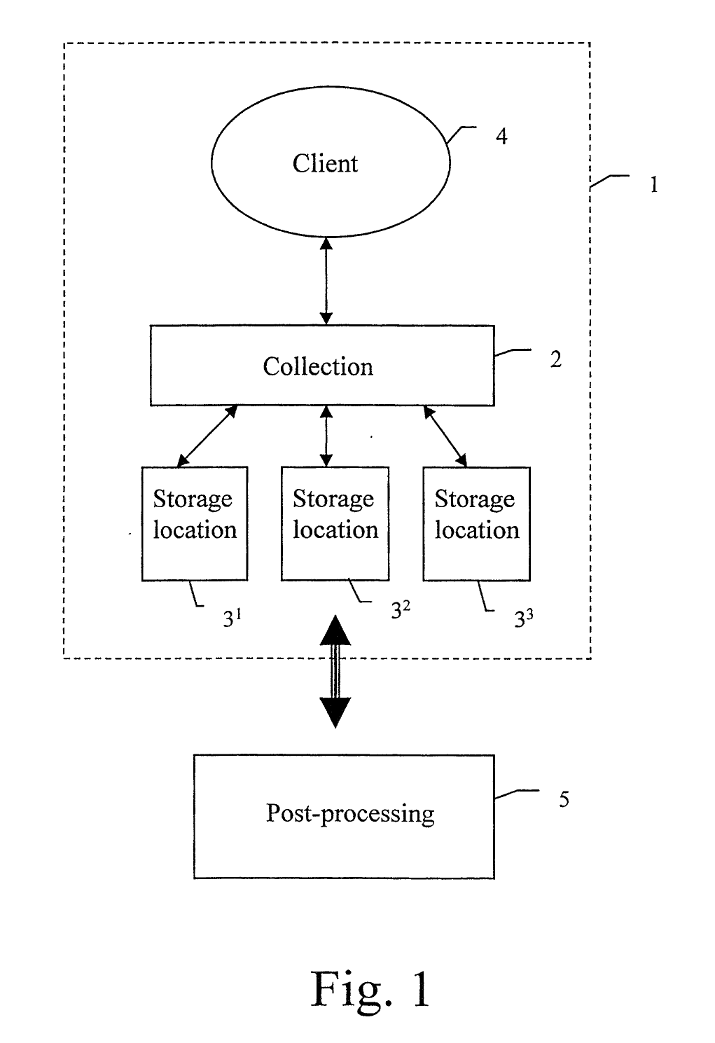

FIG. 1 is a diagrammatic illustration of a system according to the invention; and

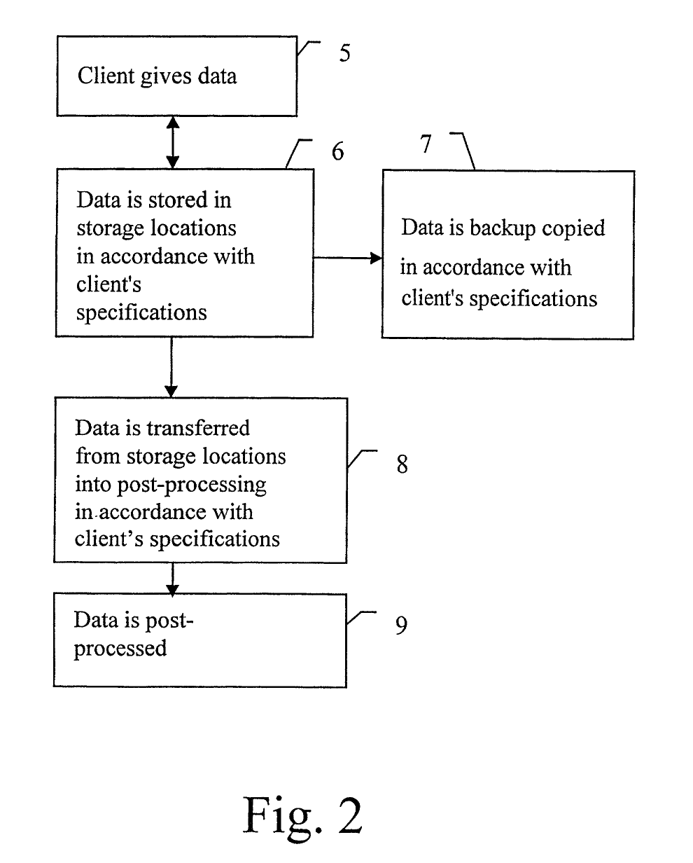

FIG. 2 is a diagrammatic illustration of a method according to the invention.

### DETAILED DESCRIPTION OF THE INVENTION

FIG. 1 presents the components of a system according to the invention. The system comprises a digital telephone exchange 1, such as e.g. a mobile switching center or a wired-network exchange. Disposed in conjunction with the exchange is a collection mechanism 2, which is used to handle data pertaining to the exchange. Furthermore, the system comprises one or more storage locations 3¹, 3², . . . , 3^{N}. In addition, the system comprises at least one client application 4 and a post-processing system 5. In addition, the system comprises at least one client application 4 and a post-processing system 5. According to the invention, the data collection mechanism 2 is of a generic type, so it can be used to collect and store any data in predetermined storage locations 3¹, 3², . . . , 3^{N}. The storage locations 3¹, 3², . . . , 3^{N} may be of a record-based or a cumulative type. The data is written to the storage locations 3¹, 3², . . . , 3^{N} in accordance with a scattering specification given by the client 4. The scattering specification indicates where each data element received is to be stored. The data received from the client application 4 of the data collection service 2 are scattered in storage locations 3¹, 3², . . . 3^{N} defined in the scattering specification. The scattering specification is made by the party requesting storage service, i.e. the party wanting to have its own data stored. The scattering specification defines where the data to be stored is to be retrieved as well as the quantity of data. The location of retrieval of the data may be a message or a file. The scattering specification defines the file and the location in the file in which the data is to be stored.

The data collection mechanism 2 allows stored data to be read afterwards. The client application 4 refers to a storage location via the scattering specification, and the data collection services 2 retrieve the contents of the storage location, which is returned to the client application 4. An essential component entity associated with data collection consists in the functions of backup copying and transfer of the collected data, by means of which e.g. metering data can be transferred to a post-processing system. The post-processing system 5 is any post-processing software, which identifies the format in which the data is delivered from the exchange. The post-processing system 5 converts the data into an intelligible, “humane” form. The data storage locations 3¹, 3², . . . , 3^{N} are transferred to post-processing in a desired format, such as e.g. ASCII or binary format. ASCII format data may be e.g. ASN.1-, NOPDF- of XML coded data. The transfer is performed either on the basis of schedules provided by the client application 4 of the data collection services 2 or, if desirable, immediately. The data collection services 2 direct the data toward the desired destination of transfer, e.g. to a network management system NMS, a billing centre or via a text formatter to a printer. In backup copying, the storage locations 3¹, 3², . . . , 3^{N} in RAM are copied to a mass storage. The copying is managed via schedules provided by the client application 4.

A request for a storage service contains an indication of where the scattering specification is to be found, i.e. a data identifier. The collection mechanism 2 knows at which points in the scattering specification the information regarding retrieval and storage of the data is to be found. The storage location 3¹, 3², . . . , 3^{N} is either a fixed or an allocable memory area, i.e. file or buffer. A fixed memory area is created at start-up of the exchange, whereas an allocable memory area is created in conjunction with the request for a storage service.

In an embodiment of the system of the invention, the system is used for data controlled compilation of statistics. In an application controlling statistical measurements, definitions are made as to what sort of data is to be stored for the statistical measurements and how measurement reports are formed on the basis of data collected. The statistical data in question include e.g. data indicating the number of calls inhibited by congestion due to insufficient capacity and the increase in traffic within a given period of time in the area of a given exchange. The collection and storage of the statistical data are performed by data collection services 2 by the aid of special scattering specifications comprised in measurement specific measurement specifications. The scattering specification comprised in the measurement specification contains information indicating the data to be collected for the measurement. The measurement specification also indicates what sort of report is to be generated from the measurement and when the measurement is to be carried out. The reports are produced using a measurement report generating mechanism 5 in accordance with the measurement specification by utilizing the data stored by the data collection services 2.

The measurement specification defines the kind of measurement to be carried out, the objects to be included in the measurement as well as the time when the measurement is to be performed. A report specification defining the type the measurement specifies the accumulators in which the data to be included in statistics is to be scattered, the calculation formulas according to which the measurement report is to be generated as well as the format of the measurement report. The calculation formulas may include e.g. addition, subtraction, multiplication and division operations. The calculation formulas define the ways in which the quantities measured are to be processed.

The report specification is integrated in the software and the operator can not modify the type data of the report specification. Instead, the operator can define a schedule to be observed in executing the measurement and a list of objects describing the objects to be included in the measurement. Thus, the measurement specification consists of two parts, a part managed by the operator and including a list of objects, a report format and a measurement schedule, and a report specification comprising the scattering specification and calculation formulas. In the case of an application-specific measurement, the report specification is provided by the application. In the case of a measurement related to the exchange 1, the report specification is part of the exchange 1. Generic report specifications pertaining to the exchange 1 include e.g. traffic measurement reports containing information about traffic intensity and distribution; load monitoring reports containing information about the load of the network element and computer units; service reports containing information about the availability, reliability and service level of a network element; and peak traffic measurement reports containing information about the time of occurrence of the peak hour and traffic intensity. Both measurements defined by the application and those defined by the exchange are managed in the exchange 1. The objects to be included in the measurement, the time of executing the measurement and the report specification to be observed can be defined separately for each measurement.

Traffic monitoring measurement reports are produced in accordance with measurement-specific measurement specifications. The mechanism 5 producing the measurement reports is of a generic nature, in other words, the same mechanism 5 can be used to produce different reports with different measurement specifications. The measuring mechanism identifies the measurement specification, which is described in a separately defined, e.g. context-dependent language, according to which the report is to be generated. In producing the measurement reports, the data collected by the data collection services 2 is read in accordance with the measurement specification, and, by using these services, calculation formulas consistent with the report specification associated with the measurement specification are generated and the measurement report is produced using the measurement report format. The report thus generated may be transferred via the data transfer service e.g. either to post-processing or to a printer. Using format specifications, it is possible to define the format in which the report is delivered from the exchange, i.e. the format understood by the external post-processing system.

In an embodiment of the system of the invention, the system is used for the processing of metering data. A metering function application 4 meters the consumption of resources and stores the metered consumption data separately for each consumer, so that the resources consumed by each consumer can be invoiced afterwards e.g. via a telephone bill. The consumption data stored may be either itemized or cumulative.

In itemized metering, for each occurrence of consumption of a resource, a number of detailed data items are stored in a separate record CDR (Charging Record). In cumulative metering, the quantity of resources consumed in a current case is added to the amount of resource consumption already recorded in the accumulator for the consumer in question. In a cumulative accumulator, it is possible to measure e.g. either the number of metering pulses, the length of time consumed or the number of calls. Call data are stored in itemized form if the application so requests or if a triggering condition defined in the exchange is fulfilled. Based on itemized call-specific information, it is possible to generate either itemized metering records or traffic monitoring reports. Separate triggering conditions can be defined both for the generation of a call-specific metering record and for the generation of a traffic monitoring report.

The generic data collection mechanism 2 is used for the storage and backup copying of metering data and for transferring the data to post-processing. In the application 4, the metering data generated are stored by means of the data collection services 2, and so are the call-specific traffic monitoring reports. A metering data storage specification describes the kind of storage locations used by the metering system. The storage specification can be used e.g. for defining subscriber-specific accumulators or call-specific metering records.

The metering data storage specification is given to the data collection services 2 when storage locations for metering data are to be created or modified. A storage specification for subscriber-specific accumulators is received from the application, whereas the storage specification for line-specific metering is part of the exchange. Via management of line-specific metering, it is possible to define those lines on which metering is to be implemented. The data collection services 2 scatter the metering data received to storage locations according to the storage specification.

The metering data relating to a call may be a pulse count or metering record stored in the subscriber accumulator or line accumulator. Metering data relating to a call may be stored in cumulative accumulators and in call-specific records. A call-specific metering record (CDR) or monitoring report or, if desirable, both, is/are generated either when the application 4 so wishes or upon the action of an exchangespecific trigger. Most of the triggering conditions for the exchange as well as their management are application-specific. However, it is possible to define in the exchange e.g. a trigger sensitive to call duration or a trigger for call failures. The observation of triggering conditions can be implemented e.g. using an attribute analysis mechanism.

The metering data is primarily stored in RAM by the data collection services 2. However, it is also possible to define a mass storage as the place of storage of the metering data. For example, call data records generated upon a request from an application or upon the action of a trigger can be taken into a mass storage via the RAM buffering provided by the data collection services 2. The metering data can be backed up by copying it from the RAM to the mass storage in accordance with backup schedules defined separately. The actual copying is performed by the data collection services, whereas the management of backup copying schedules is taken care of by the metering functions. The backup copying schedules are handed to the data collection services.

The metering data is transferred to post-processing via the data collection services. The transfer is controlled by defining a transfer schedule and a transfer format, which are given to the data collection services. The data collection services transfer the metering data in the desired format to the desired object in accordance with the desired schedule. If the metering data has been stored for quick transfer, then the data collection services will transfer the data immediately to post-processing. In conjunction with storage, the metering data may be associated with a definition prescribing the data to be transferred from storage to post-processing either in accordance with schedules or immediately. A call record can be generated either for ordinary metering or for immediate charging.

FIG. 2 is a diagrammatic illustration of a method according to the invention. First 5, the client application gives data. Next 5, the data is stored in storage locations in accordance with the client's specifications, using a generic storage mechanism. After this 7, using a generic copying mechanism, the data may be backup copied in accordance with the client's specifications and/or the data may be transferred from the storage locations into post-processing in accordance with the client's specifications using a generic transfer mechanism 8. Finally 9, post-processing operations can be performed on the data.

The invention is not restricted to the examples of its embodiments described above, but many variations are possible within the scope of the inventive idea defined in the claims

1. System for the optimization of data collection in a telecommunication network, said system comprising a digital telephone exchange (1); a collection mechanism (2) used to handle data pertaining to the telephone exchange (1); one or more storage locations (3¹, 3², . . . , 3^{N}) ; at least one client application (4) which uses the services of the collection mechanism (2); and a post-processing system (5) for post-processing of the data, characterized in that the collection mechanism (2) comprises
a generic storage mechanism (2) for storing multiple types of data in the storage locations (3¹, 3², . . . , 3^{N});
a generic transfer mechanism (2) for transferring multiple types of data from the storage locations (3¹, 3², . . . , 3^{N}) ; and
a generic copying mechanism (2) for backup copying of multiple types of data:

2. System as defined in claim 1, characterized in that the storage locations (3¹, 3², . . . , 3^{N}) are of a cumulative and/or record-based type.

3. System as defined in claim 1 or 2, characterized in that the storage locations (3¹, 3², . . . , 3^{N}) are disposed in RAM memory and/or on a mass storage device buffered via RAM.

4. System as defined in any one of claims 1-3, characterized in that the client application (4) comprises means (4) by which data is given to the data collection mechanism (2) for storage.

5. System as defined in any one of claims 1-4, characterized in that the client application (4) comprises means (4) for specifying the storage locations (3¹, 3², . . . , 3^{N}) in which the data is to be stored.

6. System as defined in any one of claims 1-5, characterized in that the client application (4) comprises means (4) for defining the time when a backup copy of the data is to be made.

7. System as defined in any one of claims 1-6, characterized in that the client application (4) comprises means (4) for specifying
when the data is to be transferred; and
in which format the data is to be transferred.

8. System as defined in any one of claims 1-7, characterized in that the post-processing system (5) comprises a generic reporting mechanism (5) used to generate a measurement report from the data.

9. System as defined in any one of claims 1-7, characterized in that the post-processing system (5) comprises means (5) for post-processing of metering data.

10. Method for optimizing data collection in a telecommunication network, in which method data pertaining to a digital telephone exchange (1) is handled by means of a collection mechanism (2) implemented in conjunction with the telephone exchange (1) in question; in which method the collection mechanism (2) is utilized by at least one client application (4) and in which method the data is post-processed using a post-processing system (5), characterized in that
data of multiple types is stored in storage locations (3¹, 3², . . . , 3^{N}) a generic storage mechanism (2);
data of multiple types is transferred from the storage locations (3¹, 3², . . . , 3^{N}) by using a generic transfer mechanism (2); ja
data of multiple types is backed up using a generic copying mechanism (2).

11. Method as defined in claim 10, characterized in that the storage locations (3¹, 3², . . . , 3^{N}) are of cumulative and/or record-based type.

12. Method as defined in claim 10 or 11, characterized in that the storage locations (3¹, 3², . . . , 3^{N}) are disposed in RAM and/or on a mass storage device buffered via RAM.

13. Method as defined in any one of claims 10-12, characterized in that the client application (4) gives the data to be stored to the collection mechanism (2).

14. Method as defined in any one of claims 10-13, characterized in that the client application (4) specifies the storage locations (3¹, 3², . . . , 3^{N}) in which the data is to be stored.

15. Method as defined in any one of claims 10-14, characterized in that the client application (4) specifies the time when the data is to be backed up.

16. Method as defined in any one of claims 10-15, characterized in that the client application (4) specifies the time when and format in which the data is to be transferred.

17. Method as defined in any one of claims 10-16, characterized in that, using a generic reporting mechanism (5), a measurement report is generated from the data during post-processing.

18. Method as defined in any one of claims 10-16, characterized in that the data processed in the post-processing system consists of metering data.
